(19) United States
(12) Patent Application Publication
(10) Pub. No.: US 2010/0263279 A1
(43) Pub. Date: Oct. 21, 2010

(54) Door With A Rotatable Shell Wall

(76) Inventor: Henricus Johannes Raymundus Antonius Pessers, Michielsgestel (NL)

Correspondence Address: LAW OFFICES OF ERIC KARICH, 2807 ST. MARK DR., MANSFIELD, TX, 76063, US

(21) Appl. No.: 12/279,788

(22) PCT Filed: Feb. 15, 2007
(86) PCT No.: PCT/NL2007/050062

§ 371 Date: Jun. 24, 2010

(30) Foreign Application Priority Data
Feb. 20, 2006 (NL) 1031193

(51) Int. Cl. E05F 15/20; E06B 3/36

(52) U.S. Cl. 49/31; 49/41

(57) ABSTRACT

A door has a rotatable shell wall that is at least in part cylindrically shaped and is provided with an entrance and an exit. The rotatable shell wall is rotatable to a preselected stationary position at which the rotatable shell wall can be arrested and at which stationary position the door is usable for both ingress and egress.

### BACKGROUND OF THE INVENTION

1. Field of the Invention

The invention relates to a door comprising a rotatable shell wall which shell wall at least in part is cylindrically shaped and is provided with an entrance and an exit.

2. Description of Related Art

A similar door is shown in DE-C-199 05 473. In the known door, the shell wall continuously rotates in order to intermittently give way to the entrance respectively the exit of the door, whilst continuously maintaining a draft resistant closure of the building in which the door is applied. The known door is not particularly suited to allow the passage of larger groups of people in view of the fact that at the time the entrance is open the exit will be closed and vice versa.

### SUMMARY OF THE INVENTION

The present invention teaches certain benefits in construction and use which give rise to the objectives described below.

The invention has as an object to provide a door which is better suited to meet the handling of larger crowds of people and at the same time being less sensitive to draft and the influence of weather conditions outside of the building in which the door is applied than other doors that are known from the prior art. Amongst these other doors are for instance the conventional revolving door as known from EP-A-0 296 134 or the revolving door known from DE-U-296 24 619.

To meet the above objectives and in order to attain other advantages that will become evident from the following disclosure the door of the invention meets the features as specified in one or more of the appended claims.

In a first aspect of the invention the door is characterized in that the rotatable shell wall is rotatable to a pre-selected stationary position at which the rotatable shell wall can be arrested and at which stationary position the door is usable for both ingress and egress.

Due to these features the door of the invention allows both the handling of larger crowds of people and meets the objective of having an improved resistance in respect of the weather conditions outside of the building in which the door is applied because it allows to elect such a stationary position that the influence of for instance wind can be largely countered.

Preferably the rotatable shell wall is rotatable in clockwise direction and in counter-clockwise direction.

This allows for a quick and easy adaptation of the door to meet the particular weather conditions that may change during the day.

Although the door of the invention may be placed in the desired stationary position by hand to meet the sought for resistance against the prevailing weather conditions, it is preferable that these are measurement means for detecting a wind direction and/or wind force and/or temperature, and that the rotatable shell wall is provided with a first drive that is coupled to said measurement means for moving the rotatable shell wall to a stationary position in dependence of the wind direction and/or wind force and/or temperature that the measurement means measure.

Although it is feasible that one can do without, it is further preferable that at its outer circumference, the rotatable shell wall has wind deflectors at both sides of the entrance and/or exit.

In this way the influence of the wind conditions can be further suppressed.

It is advantageous that the wind deflectors are movable in respect of the rotatable shell wall. This allows for adjustment of the wind deflectors to better meet the prevailing weather conditions.

To promote a quick and easy adjustment to the weather conditions outside of the building in which the door is applied, it is advantageous that the wind deflectors are arranged with second drive means that are coupled with the measurement means for moving the wind deflectors to a position depending on the wind direction and/or wind force and/or temperature that the measurement means measure.

The objectives that the invention seeks to pursue are even further promoted if the entrance and/or exit are provided with closure means that can be arrested in a preselected position at which there is a predetermined opening width of said entrance and/or exit.

The quality and ease of use of the door according to the invention is then further facilitated by the feature that the closure means are arranged with third drive means that are coupled with the measurement means for moving the closure means to a position at which there is an opening width of said entrance and/or exit depending on the wind direction and/or wind force and/or temperature that the measurement means measure.

The rotatable shell wall of the door according to the invention may at least in part also continue at the inside of the building in which the door is applied.

If however the available space in the building is limited, then it may be preferable that the rotatable shell wall comprises wall segments that are slidably connected to each other, and that there is at least one case for housing one or more of said wall segments.

Whenever the rotatable shell wall is rotated clockwise or counter-clockwise the concerning wall segments on the side to which the shell wall is rotated by then slide along each other, and be received in the case at that side without having to use any of the otherwise required space within the building.

The door of the invention may be provided with a variety of further entrance technology means, such as an air curtain or sliding doors at the entrance and/or exit. Also sliding doors may be provided within the space bounded by the rotatable shell wall, for instance at the place where otherwise the outside wall of the building in which the door of the invention is applied would be located. Such sliding doors do then not rotate together with the rotatable shell wall but are rotationally fixed.

Finally, it can be remarked that also revolving door leaves may be provided within the space bounded by the rotatable shell wall.

The invention will hereafter further be elucidated with reference to some exemplary embodiments of the door according to the invention and without limiting the appended claims.

### BRIEF DESCRIPTION OF THE DRAWINGS

The accompanying drawings illustrate the present invention. In such drawings:

FIG. 1 shows a first embodiment of the door according to the invention in a perspective view;

FIGS. 2a and 2b show a sectional top view of the door according to FIG. 1 in two differing stationary positions of the door's rotational shell wall.

FIG. 3 shows a second embodiment of the door according to the invention.

FIG. 4 shows a top sectional view of the door according to FIG. 3.

FIG. 5 shows an alternative embodiment of the door according to FIG. 3 in a top sectional view.

FIG. 6 shows a third embodiment of the door according to the invention.

FIG. 7 shows a top sectional view of the door according to FIG. 6, and

FIG. 8 shows a top sectional view of a fourth embodiment of the door according to the invention.

Wherever in the figures the same reference numerals are applied these reference numerals refer to similar parts of the door of the invention.

### DETAILED DESCRIPTION OF THE INVENTION

The above-described drawing figures illustrate the invention, a door 2 including a rotatable shell wall 7.

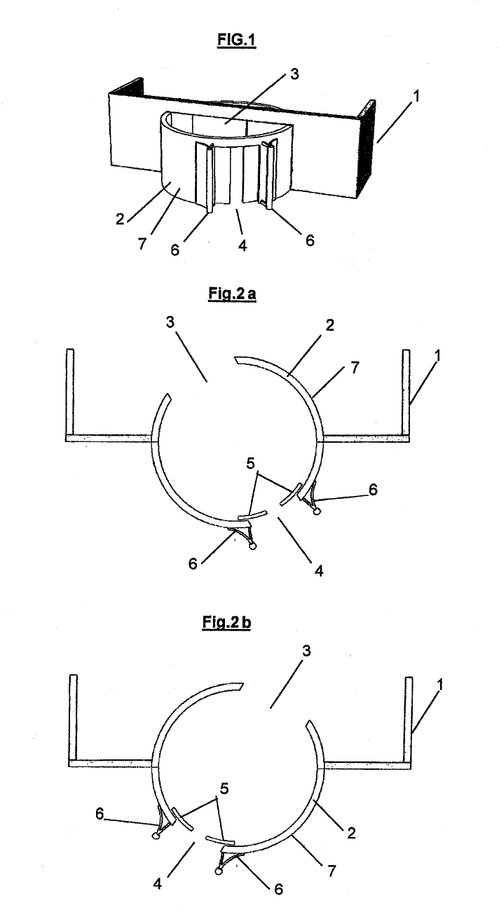

With reference first to FIG. 1 a part of an outside facade of a building 1 is shown in which the door 2 according to the invention is applied. This door 2 comprises the rotatable shell wall 7, which shell wall 7 is, as FIG. 1 clearly shows, at least in part cylindrically shaped. The door 2 is further provided with an entrance 4 and an exit 3 as is more clearly shown in FIGS. 2a and 2b.

The rotatable shell wall 7 is rotatable to a preselected stationary position, two of which are shown in FIG. 2a and FIG. 2b, respectively.

At these stationary positions, such as shown in FIG. 2a and FIG. 2b, the rotatable shell wall 2 can be arrested with an arresting element in order to realise a predetermined orientation of in particular the entrance 4 which is less sensitive to the influence of weather conditions outside of the building 1 then other positions of this entrance 4 might be.

At the arrested position of the rotatable shell wall 2 according to either FIG. 2a or FIG. 2b the door 2 can be used for both ingress and egress of persons wishing to enter or leave the building in a rather unhindered way which largely depends on further possible entrance technology which may be used in combination with the door 2 of the invention. The door 2 may for instance be provided with sliding doors 5 at the door's 2 entrance 4, which may be automatically operable upon detecting a person wishing to leave or enter the building.

It is however also possible to provide the door at the entrance 4 and/or exit 3 with an air curtain or to apply other entrance technology means.

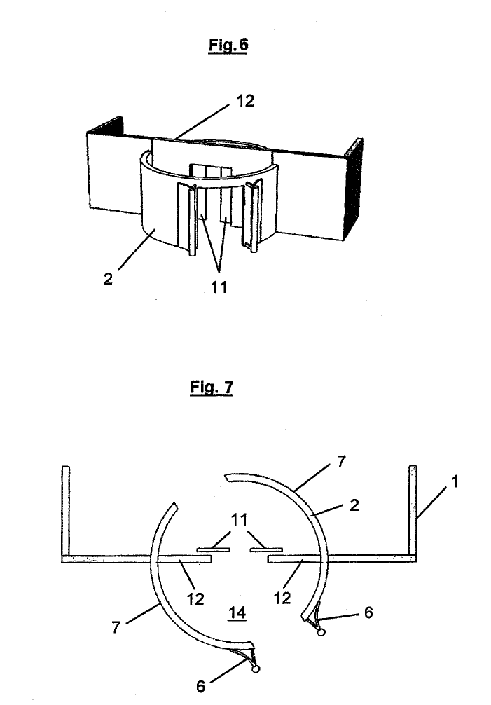

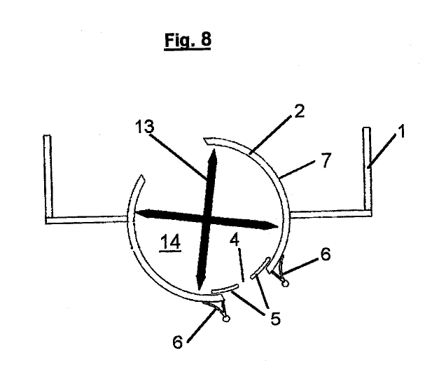

As a further example of such other technology means reference is made to FIGS. 6 and 7 showing that the door 2 is provided with sliding doors 11 within the space 14 that is bounded by the rotatable shell wall 7 and which sliding doors 11 are rotationally fixed, meaning that they do not rotate with the rotatable shell wall 7 but can only slide along the wall 12 forming part of the building 1 (see FIG. 7).

Still a further alternative and preferred embodiment is shown in FIG. 8.

FIG. 8 shows that revolving door leafs 13 are provided within the space 14 that is bounded by the rotatable shell wall 7 of the door 2 of the invention.

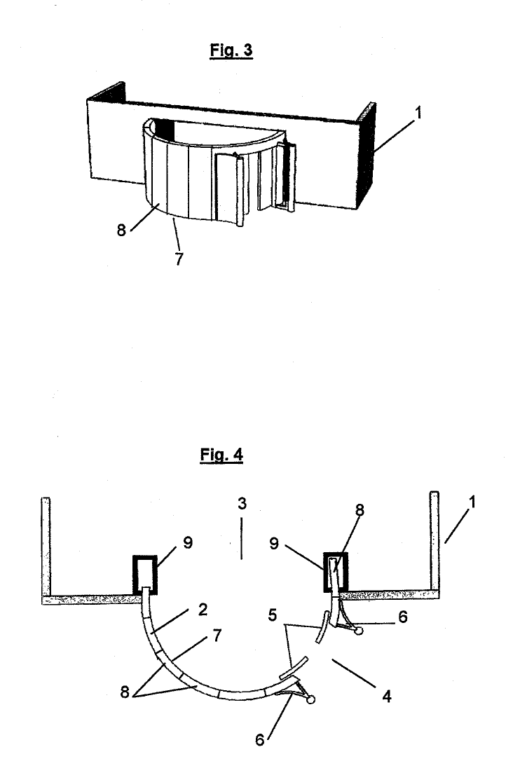

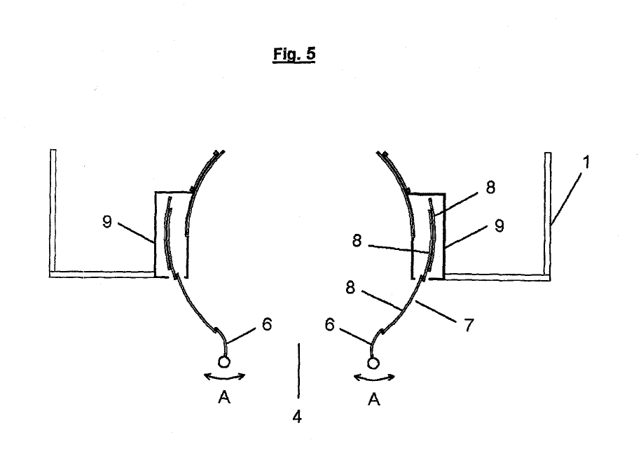

Turning now to FIG. 3 and FIG. 4 an embodiment of the door 2 of the invention is shown in which the rotatable shell wall 7 comprises wall segments 8 that are slidably connected to each other and that there is at least one case 9 for housing one or more of those wall segments 8. This is more clearly shown in the embodiment according to FIG. 5 providing a better view at the slidability of the respective wall segments 8 of the rotatable shell wall 7. The said features of the embodiments shown in FIGS. 3, 4 and 5 allow that the space occupied within the building 1 that is required for repositioning of the door 2 as elucidated above, can remain relatively restricted.

FIG. 5 as well as the other FIGS. 1-4 and 6-8 show that at its outer circumference the rotatable shell wall 7 may be provided with wind deflectors 6 that are at least provided at the sides of the entrance 4.

Said wind deflectors 6 are preferably moveable in respect of the rotatable shell wall 7 in order to allow them to be adjusted in dependence of the weather conditions outside of the building 1. The moveability of the wind deflectors 6 is indicated with the arrows A.

Turning now to FIG. 4 it is shown that the rotatable shell wall 7 may be provided with closure means in the form of sliding doors 5 that can be arrested in a pre-selected position at which there is a predetermined opening width of said entrance 4. Such closure means may however also be provided at the exit 3.

Generally speaking the rotatable shell wall 7 is preferably rotatable both in clockwise direction and in counter-clockwise direction.

Further, although not shown in the figures, there may be provided a measurement device such as a measurement means for detecting a selection of certain weather parameters such as the wind direction, the wind force, the temperature or a combination of such parameters. These parameters are used for placing the door 2 according to the invention in a desired position so as to best counter the weather conditions that prevail outside of the building 1.

To this end the rotatable shell wall 7 may then be provided with a first drive that is coupled to said measurement means for moving the rotatable shell wall 7 to any stationary position that best meets the just mentioned objective. For that purpose the first drive of the rotatable shell wall 7 is coupled to the measurement means so that the rotatable shell wall 7 is moved in dependence of the concerning weather parameter(s) that the measurement means measure.

Likewise the wind deflectors 6 shown in the respective figures may preferably be arranged with second drive means that are coupled with the measurement means for moving the wind deflectors 6 to a position that depends on the concerning weather parameter(s) that the measurement means measure.

Also the closure means 5, i.e. the sliding doors 5 shown in FIGS. 1-4 may be preferably arranged with third drive means that are coupled with said measurement means for moving these closure means 5 to a position at which they leave an opening width of the entrance 4 or exit 3 depending again on the weather conditions that prevail outside of the building 1 and that are measured by the measurement means.

From the foregoing description it will be clear that there are numerous conceivable examples and embodiments feasible within the gist of the invention as embodied in the appended claims. The scope of protection that attaches to the appended claims should consistent therewith therefore not be deemed restricted to the examples given which only serve as a guideline to remove any remaining ambiguity in the appended claims.

1. Door comprising a rotatable shell wall which shell wall at least in part is cylindrically shaped and is provided with an entrance and an exit, characterized in that the rotatable shell wall is rotatable to a pre-selected stationary position at which the rotatable shell wall can be arrested and at which stationary position the door is usable for both ingress and egress.

2. Door according to claim 1, characterized in that the rotatable shell wall is rotatable in clockwise direction and in counter-clockwise direction.

3. Door according to claim 1, characterized in that these are measurement means for detecting a wind direction and/or wind force and/or temperature, and that the rotatable shell wall is provided with a first drive that is coupled to said measurement means for moving the rotatable shell wall to a stationary position in dependence of the wind direction and/or wind force and/or temperature that the measurement means measure.

4. Door according to claim 1, characterized in that at its outer circumference, the rotatable shell wall has wind deflectors at both sides of the entrance and/or exit.

5. Door according to claim 4, characterized in that the wind deflectors are movable in respect of the rotatable shell wall.

6. Door according to claim 3, characterized in that the wind deflectors are arranged with second drive means that are coupled with the measurement means for moving the wind deflectors to a position depending on the wind direction and/or wind force and/or temperature that the measurement means measure.

7. Door according to claim 1, characterized in that the entrance and/or exit are provided with closure means that can be arrested in a pre-selected position at which there is a predetermined opening width of said entrance and/or exit.

8. Door according to claim 3, characterized in that the closure means are arranged with third drive means that are coupled with the measurement means for moving the closure means to a position at which there is an opening width of said entrance and/or exit depending on the wind direction and/or wind force and/or temperature that the measurement means measure.

9. Door according to claim 1, characterized in that the rotatable shell wall comprises wall segments that are slidably connected to each other, and that there is at least one case for housing one or more of said wall segments.

10. Door according to claim 1, characterized in that the entrance and/or exit is provided with first sliding doors and/or an air curtain.

11. Door according to claim 1, characterized in that second sliding doors are provided within a space bounded by the rotatable shell wall, which sliding doors are rotationally fixed.

12. Door according to claim 1, characterized in that revolving door leafs are provided within a space bounded by the rotatable shell wall.

13. A door comprising:
a rotatable shell wall which shell wall at least in part is cylindrically shaped and is provided with an entrance and an exit, the rotatable shell wall being rotatable to a pre-selected stationary position at which position the door is usable for both ingress and egress;
a measurement device for detecting a wind direction and/or a wind force and/or a temperature; and
a first drive that is operably engaged with the measurement device for moving the rotatable shell wall to the stationary position in dependence of the wind direction and/or wind force and or temperature.
